(19) United States
(12) Patent Application Publication
(10) Pub. No.: US 2024/0256204 A1
(43) Pub. Date: Aug. 1, 2024

(54) METHOD, APPARATUS, DEVICE, READABLE STORAGE MEDIUM AND PRODUCT FOR MEDIA FILE PROCESSING

(71) Applicant: Beijing Zitiao Network Technology Co., Ltd., Beijing (CN)

(72) Inventor: Chao Ma, Beijing (CN)

(21) Appl. No.: 18/566,333

(22) PCT Filed: May 7, 2022
(86) PCT No.: PCT/CN2022/091565

§ 371 Date: Dec. 1, 2023

(30) Foreign Application Priority Data
Jun. 30, 2021 (CN) 202110734240.4

(51) Int. Cl. G06F 3/14; G06T 3/4007

(52) U.S. Cl. CPC G06F 3/1407; G06T 3/4007

(57) ABSTRACT

Embodiments of the disclosure provide a method, apparatus, device, readable storage medium, and product for media file processing. The method includes: obtaining a media file to be displayed and determining a display size corresponding to the media file to be displayed; in accordance with a determination that the display size is smaller than an interface size of a front-end display interface, performing a size stretching operation on the media file to be displayed based on the interface size to obtain a target media file; and transmitting the target media file to the display interface for display. Since the display size of the target media file is the same as the interface size, no further stretching of the target media file is required before displaying it, thereby efficiently avoiding the problem of moiré caused by stretching the media file using a proximity difference and improving the user's viewing experience.

### CROSS REFERENCE

The present application claims priority to Chinese Patent Application No. 202110734240.4 filed on Jun. 30, 2021 and entitled “Method, Apparatus, Device, Readable Storage Medium and Product for Media File Processing”, the entirety of which is incorporated herein by reference.

### FIELD

Embodiments of the present disclosure generally relate to the technical field of image processing, and specifically, to a method for media file processing, device, electronic device, readable storage medium, computer program product and computer program.

### BACKGROUND

With the development of terminal devices and networks, short video applications have gradually entered the lives of users. In order to enable the user to view a video that better meets the user's personal preferences, the existing short video applications generally choose to analyze the user's preferences with big data and recommend video information related to the user's interests to the user.

Since the size of the video to be played may be different from the display size of the terminal device playing the video, in order to implement the normal playing of a short video, a stretching operation is performed to the short video by using a textureview control set in the terminal device. In some versions of the Android system, the control generally performs the stretching operation on the short video by using a proximity difference and displaying the stretched short video.

However, performing a stretching operation on the video by the terminal device using the above method may result in a generation of moiré in the video, affecting the user's viewing experience.

### SUMMARY

Embodiments of the present disclosure provide a method for media file processing, device, electronic device, readable storage medium, computer program product and computer program to solve the technical problem that the existing method for stretching a video would cause a generation of moiré in the video.

In a first aspect, embodiments of the present disclosure provide a method for media file processing, comprising:
obtaining a media file to be displayed and determining a display size corresponding to the media file to be displayed;
in accordance with a determination that the display size is smaller than an interface size of a front-end display interface, performing a size stretching operation on the media file to be displayed based on the interface size to obtain a target media file; and
transmitting the target media file to the display interface for display.

In a second aspect, embodiments of the present disclosure provide a device for media file processing, comprising:
an obtaining module configured to obtain a media file to be displayed and determine a display size corresponding to the media file to be displayed;
an adjusting module configured to in accordance with a determination that the display size is smaller than an interface size of a front-end display interface, perform a size stretching operation on the media file to be displayed based on the interface size to obtain a target media file; and
a display module configured to transmit the target media file to the display interface for display.

In a third aspect, embodiments of the present disclosure provide an electronic device comprising: at least one processor and a memory;
the memory storing computer-executable instructions; and
the at least one processor executing the computer-executable instructions stored in the memory to cause the at least one processor to perform a method for media file processing described in the first aspect above and various possible designs of the first aspect.

In a fourth aspect, embodiments of the present disclosure provides a computer readable storage medium having computer-executable instructions stored thereon which, when executed by a processor, cause a method for media file processing described in the first aspect above and various possible designs of the first aspect to be implemented.

In a fifth aspect, embodiments of the present disclosure provide a computer program product comprising a computer program which, when executed by a processor, causes a method for media file processing described in the first aspect above and various possible designs of the first aspect to be implemented.

In a sixth aspect, embodiments of the present disclosure provide a computer program, when executed by a processor, causing a method for media file processing described in the first aspect and various possible designs of the first aspect to be implemented.

Embodiments of the present disclosure provide a method, apparatus, device, readable storage medium, and product for media file processing. The method first obtains a media file to be displayed and determines a display size corresponding to the media file to be displayed; in accordance with a determination that the display size is smaller than an interface size of a front-end display interface, performs a size stretching operation on the media file to be displayed based on the interface size to obtain a target media file; and transmits the target media file to the display interface for display. Since the display size of the target media file is the same as the interface size, no further stretching of the target media file is required before displaying it, thereby efficiently avoiding the problem of moiré caused by stretching the media file using a proximity difference and improving the user's viewing experience.

### BRIEF DESCRIPTION OF THE DRAWINGS

In order to make the technical solution of the embodiment of the present disclosure clearer, embodiments of the present disclosure of the present disclosure will be described clearly and completely in the following in conjunction with the accompanying stretchings. Obviously, the described embodiments are a part of the embodiments of the present disclosure, not all of the embodiments. Based on the embodiments of the present disclosure, all other embodiments obtained by ordinary skill in the art without creative labor fall within the scope of protection of the present disclosure.

FIG. 1 illustrates a flowchart of a method for media file processing provided by embodiment 1 of the present disclosure;

FIG. 2 illustrates a structural schematic diagram of a media file stretching apparatus in the existing technology;

FIG. 3 illustrates a structural schematic diagram of a media file processing apparatus provided by embodiments of the present disclosure;

FIG. 4 illustrates a flowchart of a method for media file processing provided by embodiment 2 of the present disclosure;

FIG. 5 illustrates a schematic diagram of a system architecture on which embodiments of the present disclosure is based;

FIG. 6 illustrates a structural schematic diagram of a media file processing apparatus provided by embodiment 3 of the present disclosure;

FIG. 7 illustrates a structural schematic diagram of an electronic device provided by embodiment 4 of the present disclosure.

### DETAILED DESCRIPTION

In order to make the purpose, technical solution, and advantages of the embodiment of the present disclosure clearer, embodiments of the present disclosure of the present disclosure will be described clearly and completely in the following in conjunction with the accompanying drawings. Obviously, the described embodiments are a part of the embodiments of the present disclosure, not all of the embodiments. Based on the embodiments of the present disclosure, all other embodiments obtained by ordinary skill in the art without creative labor fall within the scope of protection of the present disclosure.

The present disclosure provides a method, apparatus, device, readable storage medium, and product for media file processing, for the above mentioned technical problem that the existing method for stretching a video would cause a generation of moiré in the video.

It should be noted that the method, apparatus, device, readable storage medium, and product for media file processing provided in the present disclosure can be employed in various media file stretching and displaying scenarios.

When displaying a media file on a operating system of Android 8.0 or above, if the display size of the media file is detected to be different from the size of the display interface, a stretching operation is performed to the media file by using a way of proximity difference. However, the stretching way of proximity difference can cause moiré, mosaic, and other phenomenon when the media file is zoomed in or other viewing ways, resulting in poor user viewing experience.

In the process of solving the above technical problem, the inventor discovered through research that, in order to avoid the moiré phenomenon caused by the proximity difference, before obtaining the media file and transmitting the media file to the front-end player for stretching as well as playing, an off-screen stretching module can be set up. The off-screen stretching module can perform a stretching operation on the media file in advance, so as to cause the display size of the stretched media file to be the same as the size of the front-end display interface, thereby avoiding the front-end player from using the way of proximity difference to perform the stretching operation on the media file. Thus, media files played by the front-end player will not have problems of moiré, improving the user experience.

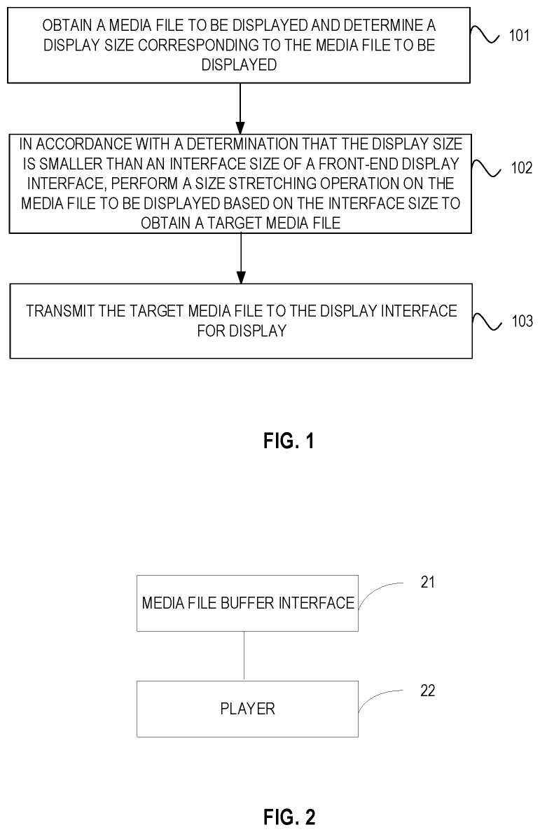

FIG. 1 illustrates a flowchart of a method for media file processing provided by embodiment 1 of the present disclosure. As shown in FIG. 1, the method comprises:

Step 101. Obtaining a media file to be displayed and determine a display size corresponding to the media file to be displayed.

The execution subject of the present embodiment is a media file processing apparatus, which may be coupled in a terminal device so as to perform a stretching operation on a media file before the media file is transmitted to the display interface for playing display.

Optionally, the media file apparatus may also be coupled in a server, which is capable of communicating and connecting with a plurality of terminal devices, so as to perform a stretching operation on the media file to be displayed by the terminal device before the display interface plays and diplays the media file.

In practice, since the display size of the media file is different from the display size of the front-end display interface, a stretch operation is required to be performed on the media file before displaying it, to cause it to maintain the same size as the front-end display interface. For example, the display size of the media file may be 480*480, while the display size of the display interface may be 1080*1080, which are different, and thus the media file is required to be stretched from 480*480 to 1080*1080.

In the present embodiment, after obtaining the media file to be displayed, a display size of the media file to be displayed may first be determined. Thereby, a subsequent comparison can be made between the display size and the display size of the front-end display interface based on the display size, to determine whether the two are the same.

Optionally, if the two sizes are not the same, a stretching operation is required to be performed on the media file to be displayed, and conversely, a display operation can be performed directly on the media file to be displayed.

Step 102. In accordance with a determination that the display size is smaller than an interface size of a front-end display interface, performing a size stretching operation on the media file to be displayed based on the interface size to obtain a target media file.

In the present embodiment, if the display size is detected to be smaller than the display size of the front-end display interface, the stretching operation is required to be performed on the media file to be displayed.

Specifically, different from the solution in the existing technology in which stretching is performed directly by the system using a proximity difference, in order to avoid the moiré phenomenon of the stretched media file, a size stretching operation can be performed on the media file to be displayed in advance to obtain the target media file before that media file to be displayed is displayed.

Step 103. Transmitting the target media file to the display interface for display.

In the present embodiment, tafter performing a size stretching operation on the media file to be displayed to obtain a target media file, the target media file may be transmitted to the display interface for display. Since the size stretching operation has already been completed for this target media file, thus the front-end does not require stretching thereof by the way of proximity difference, and thus the moiré phenomenon can be effectively avoided.

Further, on the basis of embodiment 1, the size stretching operation of the media file to be displayed based on the interface size of the interface is performed on the media file to be displayed in step 102, specifically comprising:
performing a size stretching operation on the media file to be displayed by means of linear interpolation based on the interface size.

In the present embodiment, in order to further avoid the problem of moiré due to proximity difference, in the process of off-screen stretching of the target media file, the stretching operation on the target media file may specifically be performed by a way of linear difference.

Further, on the basis of embodiment 1, after Step 102, comprises:
performing a rendering operation on the media file to be displayed of which size is stretched, to obtain the target media file.

In the present embodiment, after size stretching is performed on the media file to be displayed, a rendering operation can be further performed on the media file to be displayed to obtain the target media file.

The present embodiment provides a method for media file processing. The method first obtains a media file to be displayed and determines a display size corresponding to the media file to be displayed; in accordance with a determination that the display size is smaller than an interface size of a front-end display interface, performs an off-screen stretching operation on the media file using linear interpolation based on the size of the interface, and transmits the stretched target media file to the display interface for display. Since the display size of the target media file is the same as the interface size, no further stretching of the target media file is required before displaying it, thereby efficiently avoiding the problem of moiré caused by stretching the media file using a proximity difference and improving the user's viewing experience.

Further, on the basis of embodiment 1, Step 102 specifically comprises:
stretching the display size of the media file to be displayed to be consistent with the interface size to obtain the target media file.

In the present embodiment, in order to improve the display effect of the media file, when performing size stretching of the media file to be displayed, the display size of the media file to be displayed can be stretched to match the interface size to obtain the target media file. Thereby, the display size of the target media file can match the interface size to achieve the best display effect and improve the user experience.

Further, on the basis of embodiment 1, Step 101 specifically comprises:
invoking an original rendering buffer interface using a predetermined output rendering interface;
receiving the media file to be displayed which is output from the original rendering buffer interface, wherein the output rendering interface is created using opengl.

In the present embodiment, in order to avoid the problem of moiré due to the proximity difference, a stretching operation may be performed on the media file using the way of off-screen and the method of proximity difference before the media file is transmitted to the player for display. Specifically, an output rendering interface may be established, and the output rendering interface may be connected to the original rendering buffer interface. Thereby, when obtaining the media file to be displayed, invoke the original rendering buffer interface using the output rendering interface to obtain the media file to be displayed output by the original rendering buffer interface.

Herein, the output rendering interface can specifically be created using opengl.

Further, on the basis of embodiment 1, Step 103 specifically comprises:
transmitting the object media file to a predetermined new rendering buffer;
transmitting a notification message to a terminal device to cause the predetermined front-end player to obtain the media file to be displayed from the new rendering buffer to perform a rendering operation and display.

In the present embodiment, in order to implement the rendering operation for the stretched target media file, a new rendering buffer may also be created which is used to perform a temporary buffer operation for the stretched target media file. Specifically, the target media file may be transmitted to the predetermined new rendering buffer. And a notification message may be transmitted to the terminal device to cause the predetermined front-end player to obtain the media file to be displayed from the new rendering buffer to perform a rendering operation and display.

FIG. 2 illustrates a structural schematic diagram of a media file stretching apparatus in the existing technology. As shown in FIG. 2, after obtaining a media file output from a media file buffer interface 21, the media file is to be transmitted to a player 22 for display. A stretching operation of the media file is performed by the player 22 using a predetermined method of proximity difference.

Different from a structure of a media file stretching apparatus provided in the existing technology, in order to avoid a problem of moiré due to proximity difference, a stretching operation can be performed on a media file using the way of off-screen and the method of proximity difference before transmitting the media file to a player for display, obtaining a target media file that is the same size as the interface size of a front-end display interface, and transmitting the target media file to a front-end player for display. Thus, the front-end player is not required to perform the stretching operation on the media file.

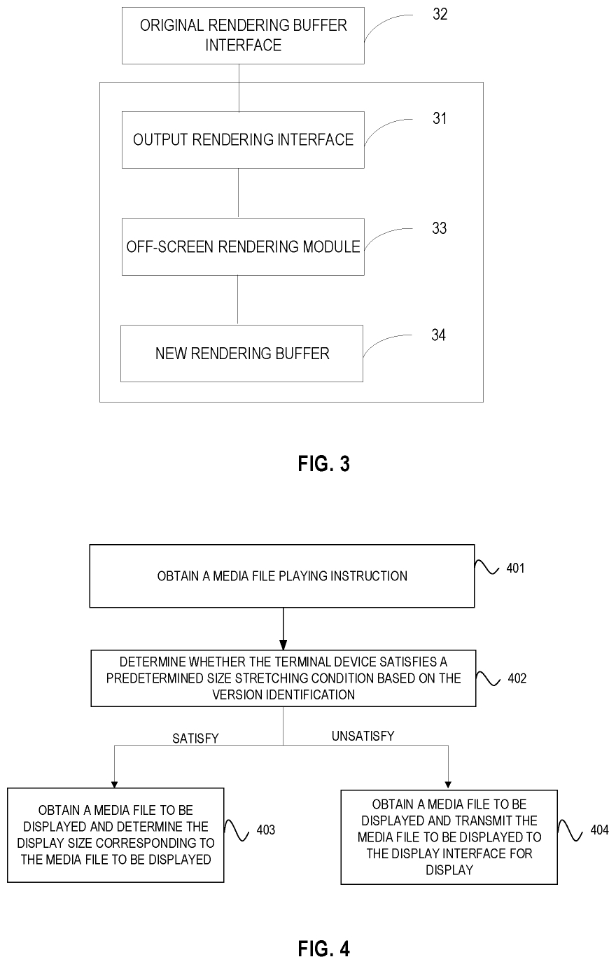

FIG. 3 illustrates a structural schematic diagram of a media file processing apparatus provided by embodiments of the present disclosure. As shown in FIG. 3, in order to implement an off-screen rendering operation on a media file to be displayed, an output rendering interface 31 may be created. The output rendering interface 31 is capable of receiving the media file to be displayed as output by an original rendering buffer interface 32. An off-screen rendering linear process is created by a predetermined off-screen rendering module 33 to perform a linear stretching operation on the media file to be displayed to obtain a target media file. An off-screen rendering module 33 may transmit the target media file to a predetermined new rendering buffer 34, so that the terminal device can obtain the target media file for display from the new rendering buffer 34.

Optionally, in the existing process of displaying media files, when the front-end player is using the original rendering buffer interface, the original rendering buffer interface may have already been released. Thus, it will lead to a crash of the front-end player, and the normal playing of the media file will not be possible, resulting in a poor users' experience.

By using the above-described method, by creating an output rendering interface to invoke the original rendering buffer interface for obtaining data, since the new output rendering interface, as well as the new rendering buffer, will not be released, the front-end player will always have a rendering buffer available. Therefore, the problem of crashing during the playing process of the media file can be avoided.

The method for media file processing provided by the present embodiment, by creating a new output rendering interface and a new rendering buffer, the off-screen stretching operation on the media file to be displayed can be implemented, and the technical problem of the front-end player crashing due to the asynchronous release of the player and the original buffer rendering area can be effectively avoided, so as to improve the displaying effect of the media file and improve the users' experience.

Further, on the basis of embodiment 1, after Step 102, further comprises:
in accordance with a determination that the display size is equal to the interface size of the front-end display interface, transmitting the media file to be displayed to the terminal device for display.

In the present embodiment, a comparison may be made between the display size of the media file to be displayed and the display size of the front-end display interface based on the display size of the media file to be displayed to determine whether the two sizes are the same. If the two sizes are detected to be of the same size, a display operation may be performed directly on the media file to be displayed. By avoiding the stretching operation on the media file to be displayed, the efficiency of displaying the media file can be improved, and the users' experience can be further improved.

FIG. 4 illustrates a flowchart of a method for media file processing provided by embodiment 2 of the present disclosure. On the basis of embodiment 1, as shown in FIG. 4, before Step 101, further comprises:

Step 401. Obtain a media file playing instruction, the media file playing instruction comprising a version identification of a terminal device.

Step 402. Determine whether the terminal device satisfies a predetermined size stretching condition based on the version identification.

Step 403. In accordance with a determination that the terminal device satisfies the predetermined size stretching condition, obtain a media file to be displayed and determine the display size corresponding to the media file to be displayed.

Step 404. In accordance with a determination that the terminal device unsatisfies the predetermined size stretching condition, obtain a media file to be displayed and transmit the media file to be displayed to the display interface for display.

In the present embodiment, the media file processing apparatus may be coupled in a server that is capable of being communicatively connected to a plurality of terminal devices. Thereby, the media file playing instructions of the plurality of terminal devices can be processed.

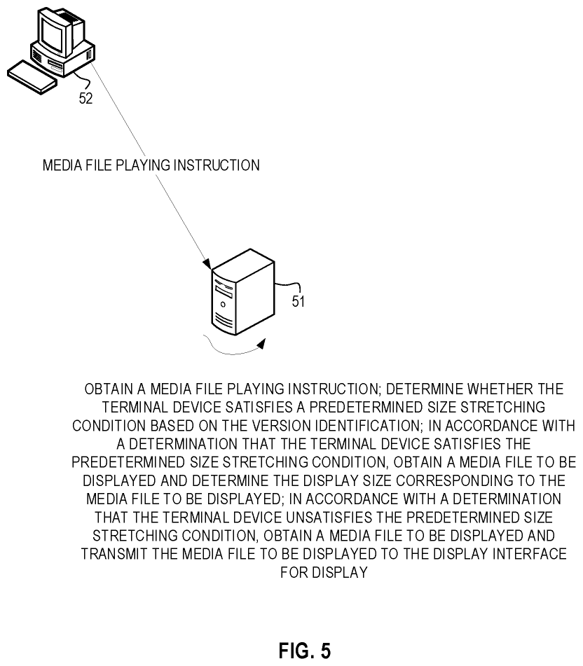

FIG. 5 illustrates a schematic diagram of a system architecture on which embodiments of the present disclosure is based. As shown in FIG. 5, the system architecture on which the present disclosure is based comprises at least a server 51 and a terminal device 52, wherein a media file processing apparatus is set up in the server 51. The media file processing device may be written in a language such as C/C++, Java, Shell, or Python; and a terminal device 1 may be, for example, a desktop computer, a tablet computer, and the like.

Based on the above system architecture, the media file processing apparatus may obtain a media file playing instruction, wherein the media file playing instruction comprises a version identification of the terminal device. Since the version of Android 8.0 or above uses a proximity difference to perform a size stretching operation on the media file, an off-screen stretching operation is required to avoid a generation of moiré after stretching. In contrast, versions below Android 8.0 use linear interpolation, which will not cause the problem of moiré. Therefore, after obtaining the media file playing instruction, a determination may first be made as to whether the terminal device satisfies the predetermined size stretching condition based on the version identification.

In accordance with a determination that the terminal device satisfies the predetermined size stretching condition, i.e., the version identification is version 8.0 or above, it is required to determine the display size corresponding to the media file to be displayed, and perform the size stretching operation based on the display size.

In contrast, in accordance with a determination that the terminal device unsatisfies the predetermined size stretching condition, i.e., when the version identification is a version below 8.0, the media file to be displayed can be directly transmitted to the display interface for display without the requirement to perform the size stretching operation.

The method for media file processing provided in the present embodiment determines whether a terminal device satisfies a predetermined size stretching condition by determining a version identification, and processes correspondingly based on the determination, so as to be able to accurately perform a size stretching operation on a media file, and to improve the display efficiency of the media file.

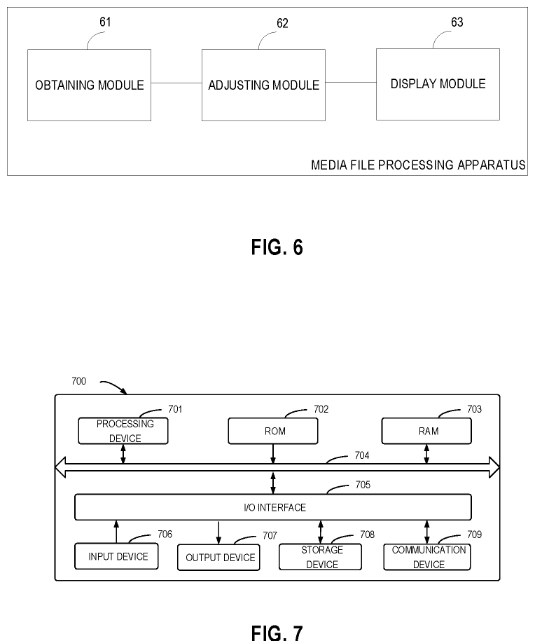

FIG. 6 illustrates a structural schematic diagram of a media file processing apparatus provided by embodiment 3 of the present disclosure. As shown in FIG. 6, the apparatus comprises: An obtaining module 61, an adjusting module 62, and a display module 63. wherein the obtaining module 61 is configured to obtain a media file to be displayed and determine a display size corresponding to the media file to be displayed. The adjusting module 62 is configured to, in accordance with a determination that the display size is smaller than an interface size of a front-end display interface, perform a size stretching operation on the media file to be displayed based on the interface size to obtain a target media file. A display module 63 is configured to transmit the target media file to the display interface for display.

Further, on the basis of embodiment 3, the adjustment module is configured to: perform a size stretching operation on the media file to be displayed by means of linear interpolation based on the interface size.

Further, on the basis of embodiment 3, the adjustment module is configured to: stretch the display size of the media file to be displayed to be consistent with the interface size to obtain the target media file.

Further, on the basis of embodiment 3, the obtaining module is configured to: invoke an original rendering buffer interface using a predetermined output rendering interface; and receive the media file to be displayed which is output from the original rendering buffer interface, wherein the output rendering interface is created using opengl.

Further, on the basis of embodiment 3, the display module is configured to: transmit the target media file to a predetermined new rendering buffer; and transmit a notification message to a terminal device to cause the predetermined front-end player to obtain the media file to be displayed from the new rendering buffer to perform a rendering operation and display.

Further, on the basis of embodiment 3, the apparatus further comprises: a transmitting module, which is further configured to, in accordance with a determination that the display size is equal to the interface size of the front-end display interface, transmit the media file to be displayed to the terminal device for display.

Further, on the basis of embodiment 3, the apparatus further comprises: an instruction obtaining module, a judging module, a processing module, and a processing module. Herein, the instruction obtaining module is configured to obtain a media file playing instruction, the media file playing instruction comprising a version identification of a terminal device. The judging module is configured to determine whether the terminal device satisfies a predetermined size stretching condition based on the version identification. The processing module is configured to, in accordance with a determination that the terminal device satisfies the predetermined size stretching condition, obtain a media file to be displayed and determine the display size corresponding to the media file to be displayed. The processing module is further configured to, in accordance with a determination that the terminal device unsatisfies the predetermined size stretching condition, obtain a media file to be displayed and transmit the media file to be displayed to the display interface for display.

Further, on the basis of embodiment 3, the apparatus further comprises: rendering module, which is configured to perform a rendering operation on the media file to be displayed of which size is stretched, to obtain the target media file.

Another embodiment of the present disclosure further provides an electronic device, comprising: at least one processor and a memory;
the memory storing computer-executable instructions; and
the at least one processor executing the computer-executable instructions stored in the memory to cause the at least one processor to perform a method for media file processing as described in any of the above embodiments.

Another embodiment of the present disclosure further provides a computer readable storage medium having computer-executable instructions stored thereon which, when executed by a processor, cause a method for media file processing as described in any of the above embodiments to be implemented.

Another embodiment of the present disclosure further provides a computer program product comprising a computer program which, when executed by a processor, causes a method for media file processing as described in any of the above embodiments to be implemented.

The device provided by the present embodiment can be used to perform the technical solutions of the method embodiments described above, which are similar in terms of the principle of implementation and technical effects, and the present embodiment will not be repeated herein.

FIG. 7 illustrates a structural schematic diagram of an electronic device provided by embodiment 4 of the present disclosure. As illustrated in FIG. 7, which illustrates a structural schematic diagram of the electronic device 700 suitable for implementing embodiments of the present disclosure. The electronic device 700 may be a terminal device or a server. Herein, the terminal device may comprise but is not limited to, such cell phones, laptop computers, digital broadcast receivers, personal digital assistants (Personal Digital Assistant, abbreviated as PDA), tablet computers (Portable Android Device, abbreviated as PAD), portable multimedia players (Portable Media Player, abbreviated as PMP), vehicle terminals (such as vehicle navigation terminals) and other mobile terminals and fixed terminals such as digital TV, desktop computers and so on. Media Player referred to as PMP), vehicle terminals (such as vehicle navigation terminals), and other mobile terminals, as well as fixed terminals such as digital TV, desktop computers, and so on. The electronic device illustrated in FIG. 9 is only an example and should not impose any limitation on the functionality and scope of use of the embodiment of the present disclosure.

As illustrated in FIG. 9, the electronic device 700 can include a processing device (such as a central processing unit, graphics processor, etc.) 701, which can execute various appropriate actions and processes according to a program stored in a read-only memory (Read Only Memory, ROM for short) 702 or loaded from a storage device 708 into a random access memory (Random Access Memory, RAM for short) 703. In the RAM 703, various programs and data required for the operation of the electronic device 700 are also stored. The processing device 701, the ROM 702, and the RAM 703 are connected to each other through the bus 704. An Input/Output (I/O) interface 705 is also connected to bus 704.

Generally, the following apparatuses can be connected to the I/O interface 705: including an input device 706 such as touch screens, touch pads, keyboards, mice, cameras, microphones, accelerometers, gyroscopes, etc.; including, for example, Liquid Crystal Display (LCD for short), an output device 707 such as a speaker, a vibrator, etc.; a storage device 708 such as a magnetic tape, a hard disk, etc.; and a communication device 709. The communication device 709 may allow the electronic device 700 to conduct wireless or wired communication with other devices to exchange data. Although FIG. 9 illustrates the electronic device 700 with various devices, it should be understood that it is not required to implement or have all of the illustrated devices. Alternatively, more, or fewer devices may be implemented or provided.

Specifically, according to the embodiments of the present disclosure, the process described above with reference to the flow diagram can be implemented as a computer software program. For example, an embodiment of the present disclosure includes a computer program product, which includes a computer program carried on a computer-readable medium, and the computer program includes a program code for executing the method shown in the flowchart. In such embodiments, the computer program can be downloaded and installed from the network through the communication device 709, installed from the storage device 708, or installed from the ROM 702. When the computer program is executed by the processing device 701, the above functions defined in the embodiment of the present disclosure are executed.

It should be noted that the computer-readable medium mentioned in the present disclosure can be a computer-readable signal medium, a computer-readable storage medium, or any combination of the two. The computer-readable storage medium can be, for example, but not limited to, an electrical, magnetic, optical, electromagnetic, infrared, or semiconductor system, apparatus, or device, or a combination of any of the above. More specific examples of the computer-readable storage medium may include but are not limited to electrical connections with one or more wires, portable computer disks, hard disks, random access memory (RAM), read-only memory (ROM), Erasable Programmable Read-Only Memory (EPROM or flash memory for short), optical fiber, Portable Compact Disk Read-Only Memory (CD-ROM for short), optical storage devices, magnetic storage devices, or any suitable combination of the above. In the present disclosure, a computer-readable storage medium may be any tangible medium that contains or stores a program, which may be used by or in combination with an instruction execution system, apparatus, or device. In the present disclosure, the computer-readable signal medium may include data signals propagated in the baseband/or as part of the carrier, wherein a computer-readable program code is carried. The propagation of data signals can adopt various forms, including but not limited to electromagnetic signals, optical signals, or any suitable combination of the above. The computer-readable signal medium can also be any computer-readable medium other than a computer-readable storage medium. The computer-readable signal medium may send, propagate, or transmit programs for use by or in combination with instruction execution systems, apparatuses, or devices. The program code contained on the computer-readable medium can be transmitted by any suitable medium, including but not limited to wire, optical cable, Radio Frequency (RF for short), etc., or any suitable combination of the above.

The computer-readable medium may be included in the electronic device, or it may exist alone without being assembled into the electronic device.

The computer-readable medium carries one or more programs, and when one or more programs are executed by the electronic device, the electronic device is caused to execute the method shown in the embodiment.

The computer program code used to execute the operations of the present disclosure may be written in one or more programming languages or a combination thereof. The programming languages include object-oriented programming languages—such as Java, Smalltalk, and C++, and also conventional procedural programming languages—such as “C” language or similar programming languages. The program code can be executed entirely on the user's computer, partly on the user's computer, executed as an independent software package, partly on the user's computer, partly executed on a remote computer, or entirely executed on the remote computer or server. In the case of a remote computer, the remote computer can be connected to the user's computer through any kind of network-including a Local Area Network (LAN for short) or a Wide Area Network (WAN for short)—or it can be connected to an external computer (for example, using an Internet service provider to connect via the Internet).

The flow diagrams and block diagrams in the accompanying drawings illustrate the possible impossible architecture, functions, and operations of systems, methods, and computer program products according to various embodiments in the present disclosure. At this point, each block in a flow diagram or block diagram can represent a module, program segment, or part of code that contains one or more executable instructions for implementing specified logical functions. It should also be noted that in some alternative implementations, the functions indicated in the blocks can also occur in a different order than those indicated in the accompanying drawings. For example, two consecutive blocks can actually be executed in parallel, and sometimes they can also be executed in the opposite order, depending on the function involved. It should also be noted that each block in the block diagram and/or flow diagram, as well as the combination of blocks in the block diagram and/or flow diagram, can be implemented using dedicated hardware-based systems that execute specified functions or operations or can be implemented using a combination of dedicated hardware and computer instructions.

The units involved in the embodiments described in the present disclosure may be implemented by way of software or by way of hardware. Herein, the name of the unit does not constitute a limitation on the unit per se under certain circumstances. For example, a first obtaining unit can also be described as “a unit for obtaining at least two Internet Protocol addresses.”

The functions described above may be at least partially executed by one or more hardware logic components. For example, without limitation, exemplary types of hardware logic components that can be used include: Field Programmable Gate Array (FPGA for short), Application Specific Integrated Circuit (ASIC for short), Application Specific Standard Product (ASSP for short), System-on-a-chip (SOC for short), Complex Programmable Logical device (CPLD for short), and so on.

In the context of the present disclosure, a machine-readable medium may be a tangible medium, which may contain or store a program for use by the instruction execution system, apparatus, or device or in combination with the instruction execution system, apparatus, or device. The machine-readable medium may be a machine-readable signal medium or a machine-readable storage medium. The machine-readable medium may include but is not limited to, an electronic, magnetic, optical, electromagnetic, infrared, or semiconductor system, apparatus, or device, or any suitable combination of the foregoing. More specific examples of machine-readable storage media would include electrical connections based on one or more wires, portable computer disks, hard disks, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

In a first aspect, according to one or more embodiments of the present disclosure, a method for media file processing is provided, comprising:
obtaining a media file to be displayed and determining a display size corresponding to the media file to be displayed;
in accordance with a determination that the display size is smaller than an interface size of a front-end display interface, performing a size stretching operation on the media file to be displayed based on the interface size to obtain a target media file; and
transmitting the target media file to the display interface for display.

According to one or more embodiments of the present disclosure, the performing a size stretching operation on the media file to be displayed based on the interface size comprises: performing a size stretching operation on the media file to be displayed by means of linear interpolation based on the interface size.

According to one or more embodiments of the present disclosure, the performing a size stretching operation on the media file to be displayed based on the interface size comprises: stretching the display size of the media file to be displayed to be consistent with the interface size to obtain the target media file.

According to one or more embodiments of the present disclosure, the obtaining a media file to be displayed, comprises: invoking an original rendering buffer interface using a predetermined output rendering interface; and receiving the media file to be displayed which is output from the original rendering buffer interface, wherein the output rendering interface is created using opengl.

According to one or more embodiments of the present disclosure, the transmitting the target media file to the display interface for display comprises: transmitting the target media file to a predetermined new rendering buffer; and transmitting a notification message to a terminal device to cause the predetermined front-end player to obtain the media file to be displayed from the new rendering buffer to perform a rendering operation and display.

According to one or more embodiments of the present disclosure, after the obtaining a media file to be displayed and determining a display size corresponding to the media file to be displayed, the method further comprises: in accordance with a determination that the display size is equal to the interface size of the front-end display interface, transmitting the media file to be displayed to the terminal device for display.

According to one or more embodiments of the present disclosure, before the obtaining the media file to be displayed, the method further comprises: obtaining a media file playing instruction, the media file playing instruction comprising a version identification of a terminal device; determining whether the terminal device satisfies a predetermined size stretching condition based on the version identification; in accordance with a determination that the terminal device satisfies the predetermined size stretching condition, obtaining a media file to be displayed and determining the display size corresponding to the media file to be displayed; and in accordance with a determination that the terminal device unsatisfies the predetermined size stretching condition, obtaining a media file to be displayed and transmitting the media file to be displayed to the display interface for display.

According to one or more embodiments of the present disclosure, after the performing a size stretching operation on the media file to be displayed based on the interface size, the method further comprises: performing a rendering operation on the media file to be displayed of which size is stretched, to obtain the target media file.

In a second aspect, according to one or more embodiments of the present disclosure, an apparatus for media file processing is provided, comprising:
an obtaining module configured to obtain a media file to be displayed and determine a display size corresponding to the media file to be displayed;
an adjusting module configured to in accordance with a determination that the display size is smaller than an interface size of a front-end display interface, perform a size stretching operation on the media file to be displayed based on the interface size to obtain a target media file; and
a display module configured to transmit the target media file to the display interface for display.

According to one or more embodiments of the present disclosure, the adjustment module is configured to: perform a size stretching operation on the media file to be displayed by means of linear interpolation based on the interface size.

According to one or more embodiments of the present disclosure, the adjustment module is configured to: stretch the display size of the media file to be displayed to be consistent with the interface size to obtain the target media file.

According to one or more embodiments of the present disclosure, the obtaining module is configured to: invoke an original rendering buffer interface using a predetermined output rendering interface; and receive the media file to be displayed which is output from the original rendering buffer interface, wherein the output rendering interface is created using opengl.

According to one or more embodiments of the present disclosure, the display module is configured to: transmit the target media file to a predetermined new rendering buffer; and transmit a notification message to a terminal device to cause the predetermined front-end player to obtain the media file to be displayed from the new rendering buffer to perform a rendering operation and display.

According to one or more embodiments of the present disclosure, the apparatus further comprises: a transmitting module, which is further configured to, in accordance with a determination that the display size is equal to the interface size of the front-end display interface, transmit the media file to be displayed to the terminal device for display.

According to one or more embodiments of the present disclosure, the apparatus further comprises: an instruction obtaining module, a judging module, a processing module, and a processing module. Herein, the instruction obtaining module is configured to obtain a media file playing instruction, the media file playing instruction comprising a version identification of a terminal device. The judging module is configured to determine whether the terminal device satisfies a predetermined size stretching condition based on the version identification. The processing module is configured to, in accordance with a determination that the terminal device satisfies the predetermined size stretching condition, obtain a media file to be displayed and determine the display size corresponding to the media file to be displayed. The processing module is further configured to, in accordance with a determination that the terminal device unsatisfies the predetermined size stretching condition, obtain a media file to be displayed and transmit the media file to be displayed to the display interface for display.

According to one or more embodiments of the present disclosure, the apparatus further comprises: rendering module, which is configured to perform a rendering operation on the media file to be displayed of which size is stretched, to obtain the target media file.

In a third aspect, according to one or more embodiments of the present disclosure, an electronic device is provided, comprising: at least one processor and a memory;
the memory storing computer-executable instructions; and
the at least one processor executing the computer-executable instructions stored in the memory to cause the at least one processor to perform a method for media file processing described in the first aspect above and various possible designs of the first aspect.

In a fourth aspect, according to one or more embodiments of the present disclosure, a computer readable storage medium is provided, having computer-executable instructions stored thereon which, when executed by a processor, cause a method for media file processing described in the first aspect above and various possible designs of the first aspect to be implemented.

In a fifth aspect, according to one or more embodiments of the present disclosure, a computer program product is provided, comprising a computer program which, when executed by a processor, causes a method for media file processing described in the first aspect above and various possible designs of the first aspect to be implemented.

In a sixth aspect, according to one or more embodiments of the present disclosure, a computer program is provided, when executed by a processor, causing a method for media file processing described in the first aspect and various possible designs of the first aspect to be implemented.

The above description is only a preferred embodiment of the present disclosure and an explanation of the principles of the technique applied. It should be understood by those skill in the art that the scope of disclosure involved in the present disclosure is not limited to technical solutions resulting from a particular combination of the aforesaid technical features but shall also cover other technical solutions resulting from any combination of the aforesaid technical features or their equivalents without being separated from the aforesaid disclosed ideas. For example, the technical scheme formed by the substitution of the above features with the technical features disclosed in the present disclosure (but not limited to) having similar functions.

Furthermore, although each operation is depicted in a specific order, this should not be understood as requiring them to be executed in the specific order shown or in a sequential order. Under certain circumstances, multitasking and parallel processing may be advantageous. Similarly, although several specific implementation details are included in the above discussion, these should not be interpreted as limiting the scope of the present disclosure. Some features described in the context of individual embodiments can also be combined and implemented in a single embodiment. On the contrary, various features described in the context of a single embodiment can also be implemented individually or in any suitable sub-combination in a plurality of embodiments.

Although the subject matter has been described in language specific to structural features and/or method logical actions, it should be understood that the subject matter limited in the accompanying claims may not necessarily be limited to the specific features or actions described above. On the contrary, the specific features and actions described above are only exemplary forms of implementing the claims.

1-13. (canceled)

14. A method for media file processing, comprising:
obtaining a media file to be displayed and determining a display size corresponding to the media file to be displayed;
in accordance with a determination that the display size is smaller than an interface size of a front-end display interface, performing a size stretching operation on the media file to be displayed based on the interface size to obtain a target media file; and
transmitting the target media file to the display interface for display.

15. The method of claim 14, wherein the performing a size stretching operation on the media file to be displayed based on the interface size comprises:
performing a size stretching operation on the media file to be displayed by means of linear interpolation based on the interface size.

16. The method of claim 14, wherein the performing a size stretching operation on the media file to be displayed based on the interface size comprises:
stretching the display size of the media file to be displayed to be consistent with the interface size to obtain the target media file.

17. The method of claim 14, wherein the obtaining a media file to be displayed, comprises:
invoking an original rendering buffer interface using a predetermined output rendering interface; and
receiving the media file to be displayed which is output from the original rendering buffer interface, wherein the output rendering interface is created using opengl.

18. The method of claim 14, wherein the transmitting the target media file to the display interface for display comprises:
transmitting the target media file to a predetermined new rendering buffer; and
transmitting a notification message to a terminal device to cause the predetermined front-end player to obtain the media file to be displayed from the new rendering buffer to perform a rendering operation and display.

19. The method of claim 14, wherein after the obtaining a media file to be displayed and determining a display size corresponding to the media file to be displayed, the method further comprises:
in accordance with a determination that the display size is equal to the interface size of the front-end display interface, transmitting the media file to be displayed to the terminal device for display.

20. The method of claim 14, wherein before the obtaining the media file to be displayed, the method further comprises:
obtaining a media file playing instruction, the media file playing instruction comprising a version identification of a terminal device;
determining whether the terminal device satisfies a predetermined size stretching condition based on the version identification;
in accordance with a determination that the terminal device satisfies the predetermined size stretching condition, obtaining a media file to be displayed and determining the display size corresponding to the media file to be displayed; and
in accordance with a determination that the terminal device unsatisfies the predetermined size stretching condition, obtaining a media file to be displayed and transmitting the media file to be displayed to the display interface for display.

21. The method of claim 14, wherein after the performing a size stretching operation on the media file to be displayed based on the interface size, the method further comprises:
performing a rendering operation on the media file to be displayed of which size is stretched, to obtain the target media file.

22. An electronic device comprising: at least one processor and a memory;
the memory storing computer-executable instructions; and
the at least one processor executing the computer-executable instructions stored in the memory to cause the at least one processor to perform a method for media file processing comprising:
obtaining a media file to be displayed and determining a display size corresponding to the media file to be displayed;
in accordance with a determination that the display size is smaller than an interface size of a front-end display interface, performing a size stretching operation on the media file to be displayed based on the interface size to obtain a target media file; and
transmitting the target media file to the display interface for display.

23. The electronic device of claim 22, wherein the performing a size stretching operation on the media file to be displayed based on the interface size comprises:
performing a size stretching operation on the media file to be displayed by means of linear interpolation based on the interface size.

24. The electronic device of claim 22, wherein the performing a size stretching operation on the media file to be displayed based on the interface size comprises:
stretching the display size of the media file to be displayed to be consistent with the interface size to obtain the target media file.

25. The electronic device of claim 22, wherein the obtaining a media file to be displayed, comprises:
invoking an original rendering buffer interface using a predetermined output rendering interface; and
receiving the media file to be displayed which is output from the original rendering buffer interface, wherein the output rendering interface is created using opengl.

26. The electronic device of claim 22, wherein the transmitting the target media file to the display interface for display comprises:
transmitting the target media file to a predetermined new rendering buffer; and
transmitting a notification message to a terminal device to cause the predetermined front-end player to obtain the media file to be displayed from the new rendering buffer to perform a rendering operation and display.

27. The electronic device of claim 22, wherein after the obtaining a media file to be displayed and determining a display size corresponding to the media file to be displayed, the method further comprises:
in accordance with a determination that the display size is equal to the interface size of the front-end display interface, transmitting the media file to be displayed to the terminal device for display.

28. The electronic device of claim 22, wherein before the obtaining the media file to be displayed, the method further comprises:
obtaining a media file playing instruction, the media file playing instruction comprising a version identification of a terminal device;
determining whether the terminal device satisfies a predetermined size stretching condition based on the version identification;
in accordance with a determination that the terminal device satisfies the predetermined size stretching condition, obtaining a media file to be displayed and determining the display size corresponding to the media file to be displayed; and
in accordance with a determination that the terminal device unsatisfies the predetermined size stretching condition, obtaining a media file to be displayed and transmitting the media file to be displayed to the display interface for display.

29. The electronic device of claim 22, wherein after the performing a size stretching operation on the media file to be displayed based on the interface size, the method further comprises:
performing a rendering operation on the media file to be displayed of which size is stretched, to obtain the target media file.

30. A non-transitory computer readable storage medium having computer-executable instructions stored thereon which, when executed by a processor, cause a method for media file processing to be implemented, the method comprising:
obtaining a media file to be displayed and determining a display size corresponding to the media file to be displayed;
in accordance with a determination that the display size is smaller than an interface size of a front-end display interface, performing a size stretching operation on the media file to be displayed based on the interface size to obtain a target media file; and
transmitting the target media file to the display interface for display.

31. The non-transitory computer readable storage medium of claim 30, wherein the performing a size stretching operation on the media file to be displayed based on the interface size comprises:
performing a size stretching operation on the media file to be displayed by means of linear interpolation based on the interface size.

32. The non-transitory computer readable storage medium of claim 30, wherein the performing a size stretching operation on the media file to be displayed based on the interface size comprises:
stretching the display size of the media file to be displayed to be consistent with the interface size to obtain the target media file.

33. The non-transitory computer readable storage medium of claim 30, wherein the obtaining a media file to be displayed, comprises:
invoking an original rendering buffer interface using a predetermined output rendering interface; and
receiving the media file to be displayed which is output from the original rendering buffer interface, wherein the output rendering interface is created using opengl.
